(19) United States
(12) Patent Application Publication
(10) Pub. No.: US 2010/0284073 A1
(43) Pub. Date: Nov. 11, 2010

(54) System and method for mounting a polarizer

(75) Inventors: Amber Iler, Ann Arbor, MI (US); Jon Diedrich, Carleton, MI (US); Patrick Hamilton, Ypsilanti, MI (US); Roger Tippets, Colorado Springs, CO (US); Tim Rogne, Ann Arbor, MI (US)

Correspondence Address: STEPTOE & JOHNSON LLP, 1330 CONNECTICUT AVENUE, N.W., WASHINGTON, DC, 20036, US

(73) Assignee: General Dynamics Advanced Information Systems, Fairfax, VA (US)

(21) Appl. No.: 12/659,344

(22) Filed: Mar. 4, 2010

Related U.S. Application Data
(60) Provisional application No. 61/202,488, filed on Mar. 4, 2009.

(51) Int. Cl. G02B 5/30

(52) U.S. Cl. 359/486

(57) ABSTRACT

A mounted polarizer and corresponding assembly method is provided. The mounted polarizer includes a substrate, and a polarizer with a plurality of parallel wires mounted on a supporting base. An epoxy binds the polarizer to the substrate, such that the plurality of parallel wires is mounted between the substrate and the supporting base, and the epoxy is in direct contact with the plurality of wires. The substrate, the epoxy and the supporting base all have a substantially matching refractive index. The mounted polarizer substantially transmits one polarization of light, and substantially blocks transmission of another polarization of light.

### BACKGROUND OF THE INVENTION

1. Field of the Invention

The present invention relates to mounting a polarizer onto a substrate. More specifically, the present invention relates to a system and method for mounting a wire-grid polarizer onto a substrate or a focal plane array.

2. Discussion of Background Information

A polarizer is generally made of multiple parallel conductive electrodes supported by a substrate. Such a device is characterized by the pitch or period of the conductors, the width of the individual conductors, and the thickness of the conductors. A beam of light produced by a light source is incident on the polarizer at an angle from normal, with the plane of incidence orthogonal to the conductive elements. The polarizer divides this beam into a reflected component, and a non-diffracted, transmitted component. For wavelengths shorter than the longest resonance wavelength, there will also be at least one higher-order diffracted component. Using the normal definitions for Sand P polarization, the light with S polarization has the polarization vector orthogonal to the plane of incidence, and thus parallel to the conductive elements. Conversely, light with P polarization has the polarization vector parallel to the plane of incidence and thus orthogonal to the conductive elements.

Ideally, the polarizer will function as a perfect mirror for one polarization of light, such as the S polarized light, and will be perfectly transparent for the other polarization, such as the P polarized light. In practice, however, even the most reflective metals used as mirrors absorb some fraction of the incident light and reflect only 90% to 95%, and plain glass does not transmit 100% of the incident light due to surface reflections.

Various types of methods have been developed for supporting the polarizer. For example, U.S. Pat. No. 6,288,840 discloses discusses embedding a wire grid between two layers resulting in a plurality of gaps between the wire grid elements, such that the gaps provide an index of refraction less than the layers. Another polarizer is described in U.S. Pat. No. 4,289,381, which discloses forming a wire grid by depositing a layer of metallization on a substrate to form the grid, then depositing substrate material over the grid. Thus the grid is encased in the substrate. A drawback of these methods is that they are complicated and expensive to manufacture, and/or the gaps can degrade overall performance of the effect of the polarizer by allowing contaminating light to enter the focal pathway.

### BRIEF DESCRIPTION OF THE DRAWINGS

FIGS. 1 A and 1 B are side and top views of an exploded mounted polarizer according to an embodiment of the invention;

FIGS. 2A and 2B are side and top views of an exploded mounted polarizer according to another embodiment of the invention;

FIGS. 3A and 3B are response/wavelength graphs for transmitted and blocked light;

FIG. 4 is a test set up for analyzing mounted polarizers according to an embodiment of the invention; and

FIGS. 5A and 5B are side and top views of an exploded mounted polarizer according to another embodiment of the invention.

### SUMMARY OF THE INVENTION

According to an embodiment of the invention, a mounted polarizer is provided. The mounted polarizer includes a substrate, and a polarizer with a plurality of parallel wires mounted on a supporting base. An epoxy binds the polarizer to the substrate, such that the plurality of parallel wires is mounted between the substrate and the supporting base, and the epoxy is in direct contact with the plurality of wires. The substrate, the epoxy and the supporting base all have a substantially matching refractive index. The mounted polarizer substantially transmits one polarization of light, and substantially blocks transmission of another polarization of light.

The above embodiment may have various optional features. The substrate and the supporting base may be made of the same material. The substrate and the supporting base may have a substantially identical refractive index. The substrate may be made of glass, or define a focal plane of an image device such as a CCD or CMOS detector. The epoxy may have a refractive index of approximately 1.7 and/or a shrinkage factor below about 1.5%. The substrate, the epoxy and the supporting base may all have refractive indexes within ±15% of each other.

According to another embodiment of the invention, a mounted polarizer is provided. It includes a substrate, a polarizer including a plurality of parallel wires mounted on a supporting base, and an epoxy. The epoxy has a shrinkage factor below about 1.5% and binds the polarizer to the substrate such that the plurality of parallel wires are mounted between the substrate and the supporting base and the epoxy is in direct contact with the plurality of wires. The substrate, the epoxy and the supporting base all have a refractive index within ±15% of each other. The mounted polarizer substantially transmits one polarization of light, and substantially blocks transmission of another polarization of light.

According to yet another embodiment of the invention, a method for mounting a polarizer is provided. The method includes providing a substrate; providing a polarizer, the polarizer including a plurality of parallel wires mounted on a supporting base; applying epoxy to the substrate; pressing the parallel wires of the polarizer into the epoxy, such that (a) the plurality of parallel wires are positioned between the substrate and the base, and (b) the epoxy is in direct contact with the plurality of wires; and curing the epoxy. The substrate, the epoxy and the supporting base all have a substantially matching refractive index.

The above embodiment may have various optional features. Before the curing, bubbles may be removed from the epoxy. The applying may include applying a substantially even thickness of epoxy. The applying may include applying epoxy substantially only on the portion of the substrate that will mate with the polarizer. The applying may include applying epoxy in at least one distinct application. The applying may include applying epoxy substantially in a shape of a perimeter of the polarizer with no epoxy within the perimeter, such that the pressing causes the epoxy to flow inward from the perimeter. The substrate and the supporting base may be made of the same material. The substrate and the supporting base may have a substantially identical refractive index. The epoxy may have a shrinkage factor below about 1.5%. The substrate, the epoxy and the supporting base may all have refractive indexes within ±15% of each other.

### DETAILED DESCRIPTION OF THE EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

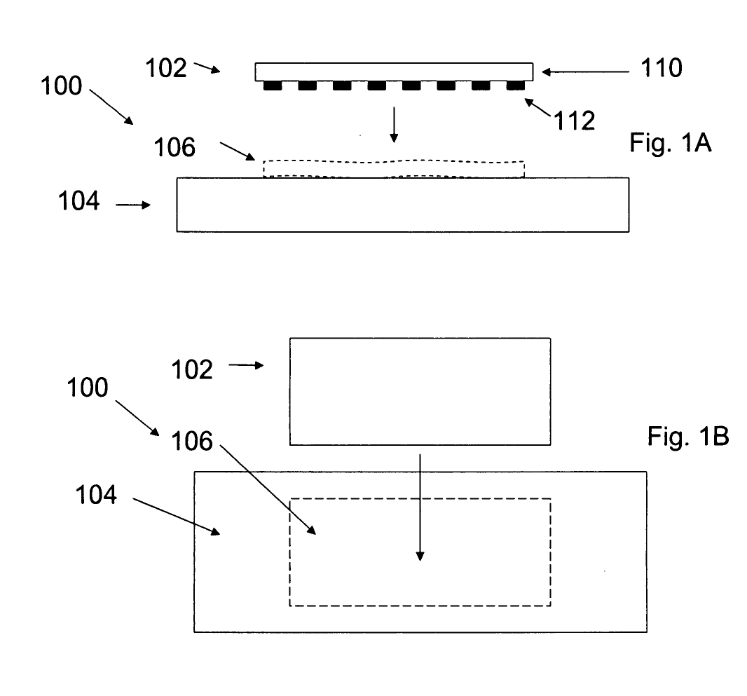

Examples of the mounting method of a polarizer onto a substrate to form a mounted polarizer 100 are shown in FIGS. 1A and 1B. A wire-grid polarizer 102 includes a plurality of parallel wires 110 mounted on a supporting base 112. An epoxy 106 is coated over the area of a substrate 104 on which the polarizer 102 will be mounted. Polarizer 102 is then pressed (wire side down) into epoxy 106 to achieve the desired separation.

Substrate 104 may be for example, a glass microscope slide, a focal plane such as a CCD or CMOS detector, or some other focal plane array. The wires 110 of polarizer 102 are preferably microgrids, which are very small strips of aluminum wires laid on glass (base 112) forming parallel lines approximately 320 nm apart. Although polarizer 102 is shown in FIGS. lA and 1B as smaller than substrate 104 in two dimensions, this is for demonstrative purposes only; polarizer 102 may have any shape relative to substrate 104 as desired and physical feasible. Preferably polarizer 102, substrate 104, and epoxy 106 each have a substantially matching refractive index. Identical indexes are preferred, but other materials within approximately ±15% may produce acceptable results. By way of example, glass can be used as both substrate 104 and base 112 of polarizer 102; glass has a refractive index of approximately 1.5, and an appropriate epoxy 106 for this environment is NORLAND 68 epoxy, which has a refractive index of approximately 1.7.

Epoxy 106 also preferably has a minimal shrinkage factor, as shrinking epoxy 106 (during curing) can place stress on the individual strands of polarizer 102. An epoxy with shrinkage of 0% is thus preferred. Shrinkage on the order of about 1-1.5% (which is on the lower end of currently available epoxy) can also be used. Shrinkage preferably does not exceed about 5%.

An example of the assembly process is as follows. The assembly occurs in an electro statically discharge safe environment to protect the polarizer 102. The epoxy 106 is applied to be a substantially even thickness on substrate 104 over substantially the entire area over which polarizer 102 will come into contact (via the epoxy 106 as an intermediate medium) with substrate 104. This results in substantially uniform coverage, so that light passing through polarizer 102 into substrate 104 will pass through substantially the same optical conditions imposed by the intervening epoxy 106. If bubble removal is necessary or desirable, a vacuum chamber can be used. The epoxy 106 may then be cured through known methods, such as an ultraviolet flood light or two part epoxy, or other methods.

The thickness of the coating of epoxy 106 is dependent upon various conditions. The lower boundary of thickness is based upon, e.g., the minimum thickness sufficient to hold the mounted polarizer 100 together under the conditions of use, and/or the minimum thickness that can be dispensed. The upper boundary is based upon, e.g., maintain structural integrity (too much epoxy may simply not dry, bubbles may form), a thickness that would begin to unacceptably degrade optical quality, and/or a thickness that would allow the polarizer to shift during curing. By way of example, for use of the embodiment with micro lenses, a thickness of approximately 5-20 microns is preferable, and more particularly 5-10 microns.

By utilizing the above methodology, the wires 110 of polarizer 102 are subject to minimal overall stress, thus avoiding damage and maintaining polarization performance. Undesirable optical effects, such as etalons, do not tend to occur.

Polarizers 102 are preferably off the shelf items or custom ordered. Currently commercial polarizers 102 tend to be sold in bulk by a limited number of manufacturers, and the characteristics are generally set by the manufacturers themselves. The end user has more flexibility in the nature of custom polarizers. Examples of the effectiveness of embodiments of the present invention with respect to commercial polarizers 102 manufactured by MOXTEK and custom by LUCENT are discussed below.

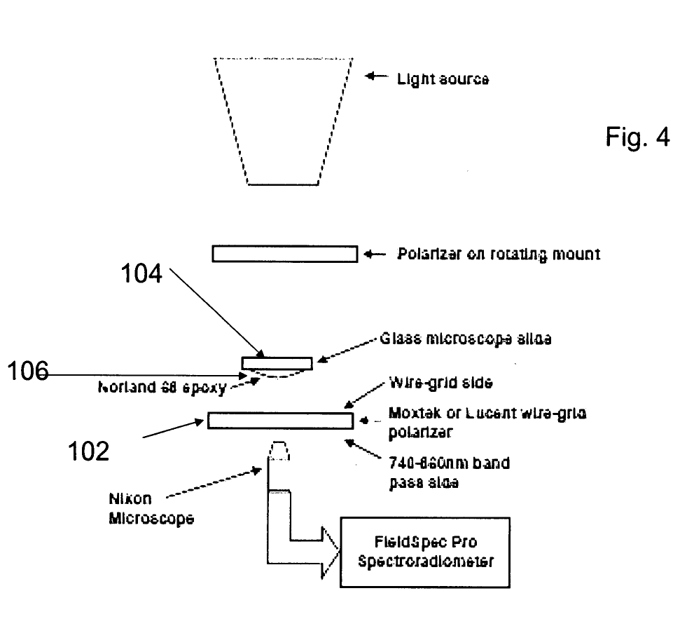

FIG. 4 shows a testing environment for testing the properties of the mounted polarizer 100. The equipment includes the light source, i.e., an unpolarized light source (integrating sphere), an additional polarizer, a Nikon microscope, e.g., a Nikon Diaphot Phase Contrast Microscope modified for microscopic analysis, and a FIELD SPEC PRO Spectroradiometer. These components are shown in FIG. 4. Using a camera, e.g., a DALSA IM15 camera for data collection and analysis, as well as software, e.g., a PIXCI ECI frame grabber with XC LIB software interface libraries and a laboratory laptop, images of the polarization can be captured showing the two polarizers in parallel and crossed positions. In a parallel position, the two polarizers should act as a bandpass filter, allowing most or all of the unpolarized light to pass. In a crossed position, the two polarizers should block most or all of the unpolarized light.

Several polarimeters assembled using the above embodiments were tested with the noted test equipment. The polarizers 102 were all uniform in size. Applicants measured the microgrid of the three (3) aluminum wire commercial polarizers 102. The first two polarizers A and B are commercial MOXTEK polarizers, and polarizer C was a custom ordered polarizers. The results were as follows:

TABLE 1

| Sample | Manufacturer | Width (μm) | Pitch (μm) | Period (μm) |
|---|---|---|---|---|
| A | MOXTEK | 0.08206 | 0.05556 | 0.13762 |
| | (commercial) | | | |
| B | MOXTEK | 0.1085 | 0.039690 | 0.14819 |
| | (commercial) | | | |
| C | LUCENT | 0.1746 | 0.124400 | 0.299 |
| | (custom) | | | |

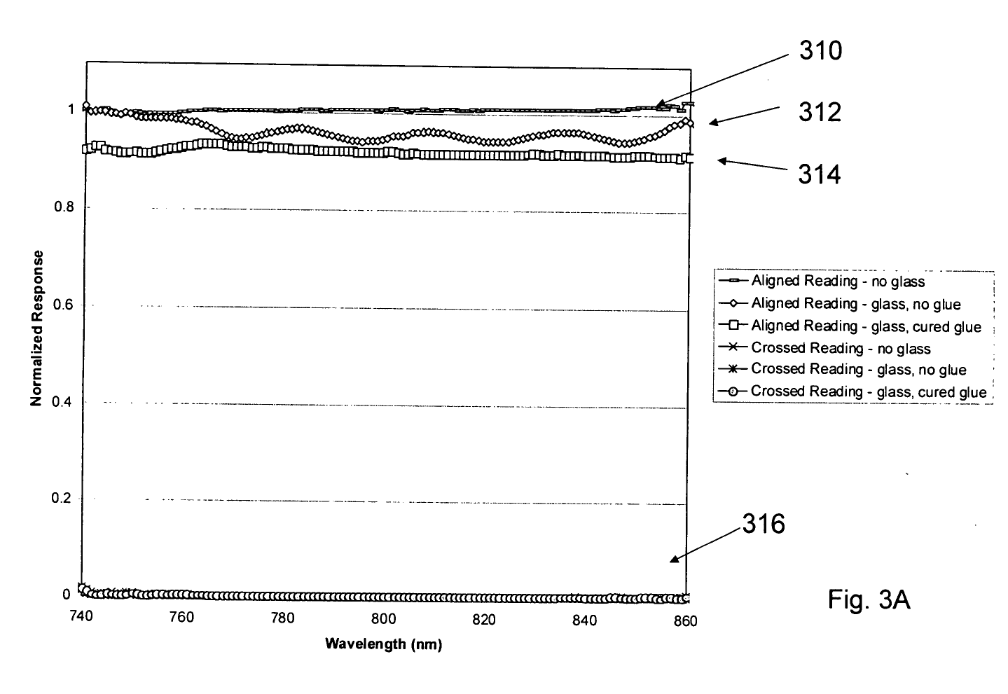

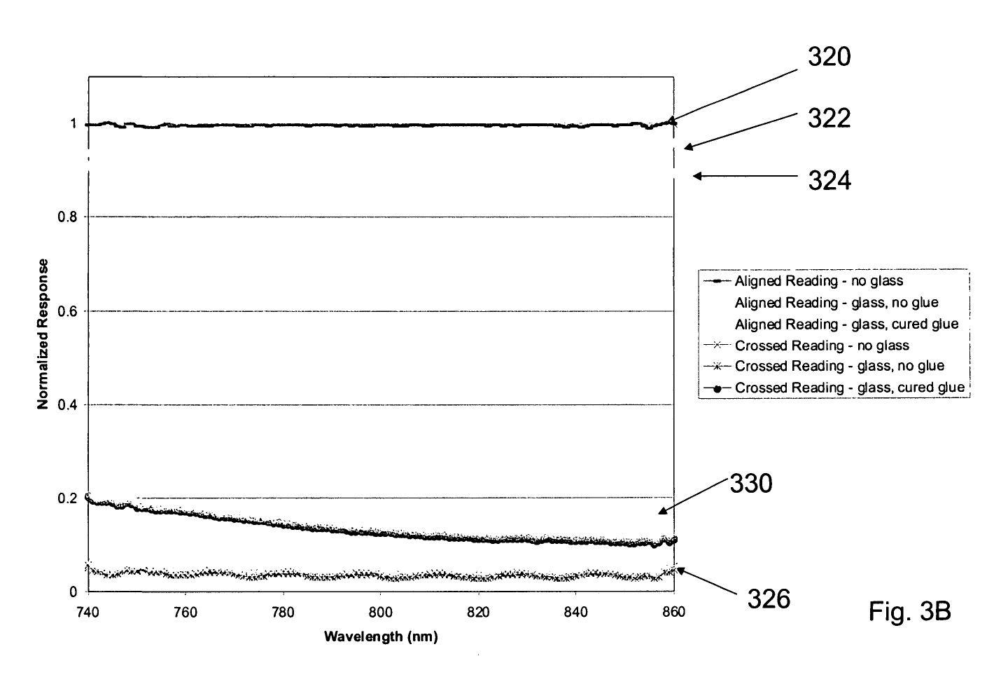

The applied measuring methodology has degree of error of about ±10%, so the above data should be understood as “on the order of.” In each case the test setup and data collection method was the same, using light (via a bandpass filter) between 740 and 860 μm. FIG. 3A shows the spectral response transmission and blockage of light for polarizer A. Perfect transmission of 100% would be a value of “1” on a normalized response curve, while perfect reflection (0% transmission) would be a value of zero.

For two unmounted (e.g., no support for the polarizer at all) polarizers A, the baseline transmission response curve 310 (for aligned polarizers) was approximately 1, or 100% transmission. The transmission response curve 314 for two polarizers 102 mounted on a glass substrate 104 with epoxy 106 according to the embodiments herein was on the order of 90%. This curve is only a slight degradation compared to the 90-95% transmission response curve 312 for the polarizers 102 mounted on substrate 104 without epoxy 106, but the significantly flat slope of curve 314 reflects the lack of etalons compared to curve 312 (in which the etalons manifest via waves in the curve 312). These are high performance results, although for transmission purposes substantially lower values could be tolerated (e.g., 50% transmission).

Applicants note that the measurements of FIG. 3A carry a fair degree of error, so the above data should be understood as on “on the order of” with variations plus or minus 3-5%. FIG. 3A also shows that transmission response curve 316 for crossed polarizers 102 were all substantially zero for unmounted polarizers, mounted polarizers with epoxy, and mounted polarizers without epoxy (the three curves all overlap at the near zero level, and are thus represented by a single curve 316). These values are relatively high performance. Polarizers that limit transmission to 2-3% may be acceptable for some application; 5% transmission would likely exceed acceptable parameters for most applications.

Wires 110 of polarizers 102 are extremely small and fragile, and typically efforts are made to prevent any direct contact between wires 110 and foreign substances. The application of epoxy 106 was expected to fail, in that epoxy 106 was expected to cause significant damage to wires 110 and render polarizer 102 effectively useless. Applicants were surprised by the effective results shown in FIG. 3A.

Spectral responses of polarizer B under the same light were akin to those of polarizer A in FIG. 3A, and are thus not independently reproduced herein.

FIG. 3B shows the spectral response for transmission and blockage of light between 740 and 860 μm for the C polarizer. Polarizer C had transmission responses curves 320, 322 and 324 akin to those of polarizers A and B discussed with respect to FIG. 3A. Yet for blocking light, the resulting transmission response curve 326 for polarizer C alone (and for the substantially overlapping curve for polarizers and glass without epoxy), the transmission of light is about 5%, which is at the outer bounds of acceptable transmission. The transmission response curve 330 for polarizer C mounted via the embodiments herein shows transmission on the order of 10-20%, which exceeds what would typically be considered acceptable levels for most applications.

By way of possible explanation on the different results for polarizers A and C, the measurements of Table 1 show that the wires 110 in polarizer C are twice as wide as the other samples A and B. The pitch of the polarizer C wires 110 is also about twice the wavelength of the light analyzed, whereas the pitch of the other polarizers A and B are closer to five (5) times the wavelength of light analyzed. Applicants surmise that the relationship between the wavelength of the applied light and the pitch of the wires 110 leads to the noted results, in that a pitch which is closer to five (5) times the wavelength of applied light will yield superior results to a pitch which is closer to two (2) times the wavelength of the applied light.

Applicants tested the above by varying the wavelength of the applied light and monitoring the response for crossed wires, and specifically whether lowering the wavelength of the light caused a corresponding reduction in light transmission for crossed wires in polarizer C. Observed data indicated a trend to support this, although considerable measurement errors were observed. These observed trends suggest that the above embodiment would achieve superior results with polarizer C for lower wavelength (red or near infra red light) applications. Commercial polarizers from the manufacturer of polarizer C were not tested, but may possibly provide superior results to the custom polarizer.

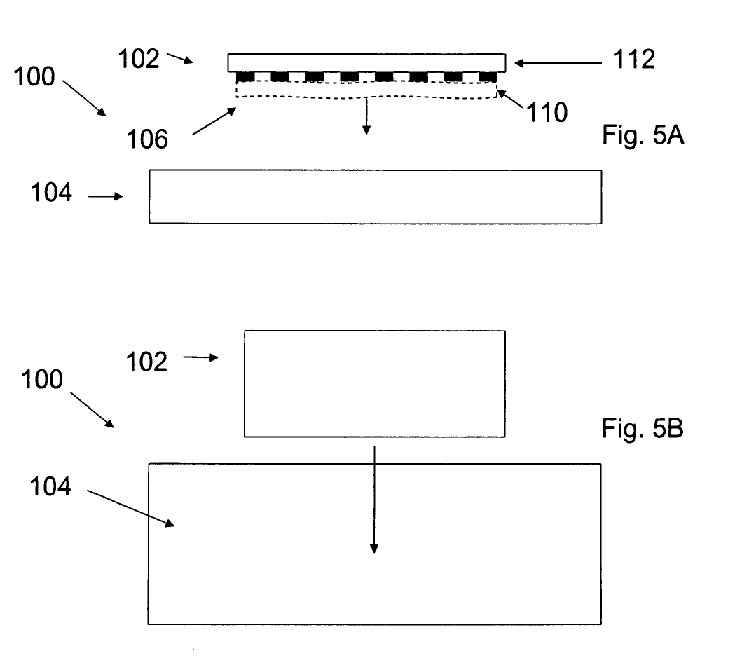

Referring now to FIGS. 5A and 5B, a variation to the above embodiment involves application of epoxy 106 directly to the polarizer 102 before mounting to the substrate 104. Care should be taken in the application of the epoxy 106 to prevent damage to the wires 110.

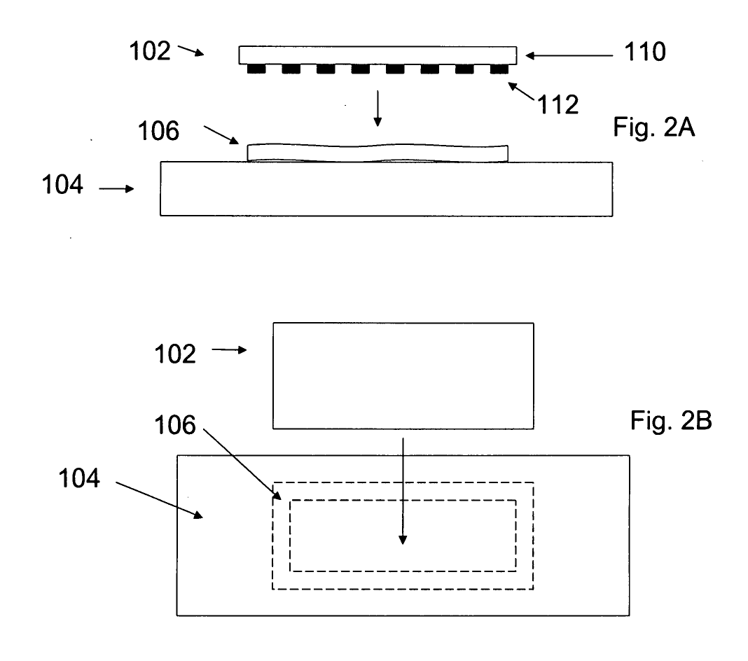

Another variation to the above embodiment involves application of epoxy 106 on substrate 104 (or on polarizer 102, not shown) in a pattern to form an edge of a periphery of polarizer 102, such as shown in FIGS. 2A and 2B. This configuration tends to form a slight air gap between the polarizer 102 and substrate 104 with resulting optical distortions such as etalons. Epoxy 106 tends to wick toward the center of the polarizer, thus creating unevenness in the pass through area of the polarizer (e.g., some areas have wicked glue, while other areas have an air gap). It is also considerably more difficult to accurately attach the polarizer 102 with this edge formation of epoxy 106 as opposed to a full layer as discussed above. The embodiment is thus within the scope of the invention, but its effectiveness is likely to be inferior to other embodiments discussed herein.

In a preferred embodiment, substrate 104 is the outer portion of an optical device, such as a camera or a video recorder. The mounted polarizer 100 is preferably sandwiched between a microlens structure and a focal plane array. The polarizer is attached to an optical filter (band pass or otherwise), preferably on the base 112 side, but possibly on the wire 110 side (an additional layer of epoxy 106 may be necessary). The mounted polarizer 100 may also be mounted to windows/glass. The invention is not limited to any particular type of substrate to which the polarizer may be applied.

In the preferred embodiment, the epoxy is applied in one application. However, the invention is not so limited, in that it could be applied over multiple applications.

Although the embodiments as discussed herein refer to aluminum polarizers, the invention is not so limited. Any polarizer of any material may be used.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A mounted polarizer, comprising:
a substrate;
a polarizer including a plurality of parallel wires mounted on a supporting base;
an epoxy binding the polarizer to the substrate, such that the plurality of parallel wires is mounted between the substrate and the supporting base, and the epoxy is in direct contact with the plurality of wires; and
the substrate, the epoxy and the supporting base all having a substantially matching refractive index;
wherein the mounted polarizer substantially transmits one polarization of light, and substantially blocks transmission of another polarization of light.

2. The mounted polarizer of claim 1, wherein the substrate and the supporting base are made of the same material.

3. The mounted polarizer of claim 1, wherein the substrate and the supporting base have a substantially identical refractive index.

4. The mounted polarizer of claim 1, wherein the substrate is made of glass.

5. The mounted polarizer of claim 1, wherein the substrate defines a focal plane of an image device.

6. The mounted polarizer of claim 5, wherein the image device is a CCD or CMOS detector.

7. The mounted polarizer of claim 1, wherein the epoxy has a refractive index of approximately 1.7.

8. The mounted polarizer of claim 1, wherein the epoxy has a shrinkage factor below about 1.5%.

9. The mounted polarizer of claim 1, wherein the substrate, the epoxy and the supporting base all have refractive indexes within ±15% of each other.

10. A mounted polarizer, comprising:
a substrate;
a polarizer including a plurality of parallel wires mounted on a supporting base;
an epoxy, having a shrinkage factor below about 1.5%, binding the polarizer to the substrate, such that the plurality of parallel wires are mounted between the substrate and the supporting base, and the epoxy is in direct contact with the plurality of wires; and
the substrate, the epoxy and the supporting base all having a refractive index within ±15% of each other;
wherein the mounted polarizer substantially transmits one polarization of light, and substantially blocks transmission of another polarization of light.

11. A method for mounting a polarizer, comprising:
providing a substrate;
providing a polarizer, the polarizer including a plurality of parallel wires mounted on a supporting base;
applying epoxy to the substrate;
pressing the parallel wires of the polarizer into the epoxy, such that (a) the plurality of parallel wires are positioned between the substrate and the supporting base, and (b) the epoxy is in direct contact with the plurality of wires; and
curing the epoxy;
wherein the substrate, the epoxy and the supporting base all having a substantially matching refractive index.

12. The method of claim 11, further comprising removing, before the curing, bubbles from the epoxy.

13. The method of claim 11, wherein the applying comprises applying a substantially even thickness of the epoxy.

14. The method of claim 11, wherein the applying comprises applying the epoxy substantially only on the portion of the substrate that will mate with the polarizer.

15. The method of claim 11, wherein the applying comprises applying the epoxy in at least one distinct application.

16. The method of claim 11, wherein the applying comprises applying epoxy substantially in a shape of a perimeter of the polarizer with no epoxy within the perimeter, and wherein the pressing causes the epoxy to flow inward from the perimeter.

17. The mounted polarizer of claim 11, wherein the substrate and the supporting base are made of the same material.

18. The mounted polarizer of claim 11, wherein the substrate and the supporting base have a substantially identical refractive index.

19. The mounted polarizer of claim 1, wherein the epoxy has a shrinkage factor below about 1.5%.

20. The mounted polarizer of claim 1, wherein the substrate, the epoxy and the supporting base all have refractive indexes within ±15% of each other.
